(19) United States
(12) Patent Application Publication
(10) Pub. No.: US 2024/0261823 A1
(43) Pub. Date: Aug. 8, 2024

(54) OPTICAL SORTER

(71) Applicant: SATAKE CORPORATION, Chiyoda-ku, Tokyo (JP)

(72) Inventors: Kohtaro OKIMOTO, Chiyoda-ku, Tokyo (JP); Tomoyuki MIYAMOTO, Chiyoda-ku, Tokyo (JP)

(73) Assignee: SATAKE CORPORATION, Chiyoda-ku, Tokyo (JP)

(21) Appl. No.: 18/567,045

(22) PCT Filed: Jun. 17, 2022
(86) PCT No.: PCT/JP2022/024307

§ 371 Date: Dec. 5, 2023

(30) Foreign Application Priority Data
Jun. 17, 2021 (JP) 2021-101185

(51) Int. Cl. B07C 5/342; B07C 5/36

(52) U.S. Cl. CPC B07C 5/3425; B07C 5/366; B07C 5/368

(57) ABSTRACT

An optical sorter includes a transport means for transporting sorting targets, a discrimination means for optically discriminating the sorting targets, a sorting means for sorting the sorting targets based on the result of discrimination of the discrimination means, and a guide plate adapted to be contacted by the sorting targets thrown out from the transport means so as to guide the sorting targets to fall in a given falling direction, in which the guide plate includes a guide face and an opening, the guide face being capable of being contacted by the sorting targets, and the opening being provided to the guide face and penetrating the guide plate, the sorting means is arranged around the opening, and the position of the guide plate relative to the fall-down path of the sorting targets is adjustable together with the sorting means.

### TECHNICAL FIELD

The present invention relates to an optical sorter that can sort sorting targets discriminated by a discrimination means.

### BACKGROUND ART

Conventionally, an optical sorter is known that images sorting targets, such as grains or resin pieces, and thus can sort the sorting targets based on image information obtained through the imaging. For example, Patent Literature 1 discloses an optical sorter including a discrimination means for discriminating the type of resin pieces, a sorting means for sorting the resin pieces discriminated by the discrimination means by blowing air thereto, and a conveyor belt that conveys the resin pieces.

The optical sorter includes an air blower portion, which generates an airflow having a wind speed that matches the transporting speed of the conveyor belt in the same direction as the falling direction of resin pieces thrown out from the conveyor belt, to maintain the fall-down path of the resin pieces constant. Such a configuration allows the resin pieces thrown out from the conveyor belt to fly with the airflow so that the fall-down path of the resin pieces is maintained constant.

Patent Literature 2 discloses an optical sorter with a configuration in which a curved guide plate is provided on the downstream of a conveyor belt. That is, all of foods thrown out from the conveyor belt are allowed to fall onto a face of the guide plate in a pressurized state so that the fall-down path of the foods is maintained constant.

### CITATION LIST

### Patent Literature

[Patent Literature 1] Japanese Patent Laid-Open No. 2016-117038
[Patent Literature 2] Japanese Patent Laid-Open No. 2003-245611

### SUMMARY OF INVENTION

### Technical Problem

However, although the invention disclosed in Patent Literature 1 above can maintain the fall-down path of resin pieces constant, it is necessary to additionally provide an air blower portion. This may result in an increase size of the device, and may also result in an increased initial cost for producing the device as well as an increased running cost for operating the device.

In the invention disclosed in Patent Literature 2 above, the foregoing guide plate is fixed in place in a manner blocking the jumping direction (i.e., the fall-down path) of foods so as to allow all of foods thrown out from the conveyor belt to be pressurized with the guide plate. Thus, when the sorting targets are those having a relatively hard surface, such as beans, in particular, there is a possibility that the sorting targets thrown out from the conveyor belt may bounce off the guide plate, with the result that the fall-down path of the sorting targets may greatly deviate from the ordinary fall-down path.

FIG. 1 is an exemplary schematic side view illustrating an aspect of sorting of sorting targets 2 of the conventional technology. That is, the quality of the sorting targets 2 transported by a transport means 3, such as a conveyor belt, is discriminated by a discrimination means 4, such as an imaging device, while the sorting targets 2 are falling. Then, the sorting targets 2 are sorted into non-defective ones and defective ones, for example, by a sorting means 6, such as an ejector, based on the result of discrimination of the discrimination means 4. The sorting targets 2 thrown out from the transport means 3 are influenced by air resistance and the like so that some of them do not fall along the ordinary fall-down path indicated by the dashed line. Thus, the fall-down path spreads wide.

Due to such circumstances, it is necessary to provide a predetermined gap (indicated by L in the drawing) as the distance between the ordinary fall-down path and the sorting means 6 so that the sorting targets 2 will not collide with the sorting means 6.

However, when such a gap (indicated by L in the drawing) is provided, it is concerned that defective sorting targets may not be exposed to a jet of air ejected by the sorting means 6, such as an ejector, for example, or in some cases, non-defective sorting targets may be exposed to the jet of air, with the result that sorting failures may occur, or a decrease in the yield of non-defective sorting targets may occur.

In view of each of the foregoing problems, a technical object of the present invention is to provide an optical sorter that can appropriately sort sorting targets discriminated by a discrimination means.

### Solution to Problem

The invention according to (1) is an optical sorter including transport means for transporting sorting targets, discrimination means for optically discriminating the sorting targets, sorting means for sorting the sorting targets based on a result of discrimination of the discrimination means, and a guide plate adapted to be contacted by the sorting targets thrown out from the transport means so as to guide the sorting targets to fall in a given falling direction, in which the guide plate includes a guide face and an opening, the guide face being capable of being contacted by the sorting targets, and the opening being provided to the guide face and penetrating the guide plate, the sorting means is arranged around the opening, the sorting means being capable of sorting the sorting targets passing through a region ahead of the opening, and a position of the guide plate relative to a fall-down path of the sorting targets is adjustable together with the sorting means.

The invention according to (2) is the optical sorter described in (1) above in which an angle of the guide plate relative to the fall-down path of the sorting targets is adjustable.

The invention according to (3) is the optical sorter described in (1) or (2) above in which a horizontal distance of the guide plate from a position of the transport means where the sorting targets are thrown out is adjustable.

The invention according to (4) is the optical sorter described in any of (1) to (3) above in which a vertical distance of the guide plate from a position of the transport means where the sorting targets are thrown out is adjustable.

The invention according to (5) is the optical sorter described in any of (1) to (4) above in which the guide plate is arranged at one or each of a position below and a position above the sorting targets thrown out from the transport means.

### Advantageous Effects of Invention

According to the invention of (1) above, a guide plate is provided that has an adjustable position relative to the fall-down path of sorting targets, and the sorting targets can be sorted by a sorting means provided around the guide plate. Providing such a guide plate can prevent the fall-down path of sorting targets, which have been thrown out from of a transport means, from spreading wide. Further, it is possible to significantly reduce the gap between the sorting means and the ordinary fall-down path of the sorting targets, and thus increase the sorting accuracy for the sorting targets.

Further, providing a guide plate, which has an adjustable position relative to the fall-down path of sorting targets, can suppress the bounce of the sorting targets off the guide plate. Besides, the guide plate can be arranged at an appropriate position where high sorting accuracy is achieved in accordance with various conditions, such as the types of the sorting targets, the type of the transport means, and the speed of the sorting targets thrown out from the transport means.

According to the invention of each of (2) to (4) above, the guide plate is configured such that it has an adjustable angle relative to the fall-down path of the sorting targets, or an adjustable horizontal or vertical distance from the position of the transport means where the sorting targets are thrown out. Thus, it is possible to finely adjust the position or the angle of the guide plate relative to the fall-down path of the sorting targets, and thus increase the sorting accuracy for the sorting targets.

According to the invention of (5) above, the guide plate is configured such that it can be arranged at one or each of a position below and a position above the sorting targets thrown out from the transport means as in each of the embodiments illustrated in FIGS. 2 to 7. Thus, there is no structural limitation, and the guide plate can be provided in various types of optical sorters.

### BRIEF DESCRIPTION OF DRAWINGS

FIG. 1 is a schematic side view illustrating an aspect of sorting of sorting targets of the conventional technology.

FIG. 2A is a schematic side view illustrating an aspect of sorting of sorting targets according to an embodiment of the present invention, which illustrates an aspect of falling of the sorting targets.

FIG. 2B is a schematic side view illustrating an aspect of sorting of the sorting targets according to the embodiment of the present invention, which illustrates an enlarged side view of a guide plate.

FIG. 3A is a view illustrating a movable aspect of a guide plate according to an embodiment of the present invention, which illustrates an aspect of falling of sorting targets.

FIG. 3B is a view illustrating the movable aspect of the guide plate according to the embodiment of the present invention, which illustrates the movable range of the guide plate.

FIG. 4 is a schematic side view illustrating an aspect in which ejectors are provided at a plurality portions of a guide plate according to another embodiment of the present invention.

FIG. 5 is a schematic side view illustrating an aspect in which a guide plate is provided at a position below sorting targets thrown out from a transport means according to another embodiment of the present invention.

FIG. 6 is a schematic side view illustrating an aspect in which a guide plate is provided at a position below sorting targets thrown out from a transport means, and ejectors are provided at a plurality portions of the guide plate according to another embodiment of the present invention.

FIG. 7 is a schematic side view illustrating an aspect in which guide plates are provided at positions below and above sorting targets thrown out from a transport means, and each guide plate is provided with an ejector according to another embodiment of the present invention.

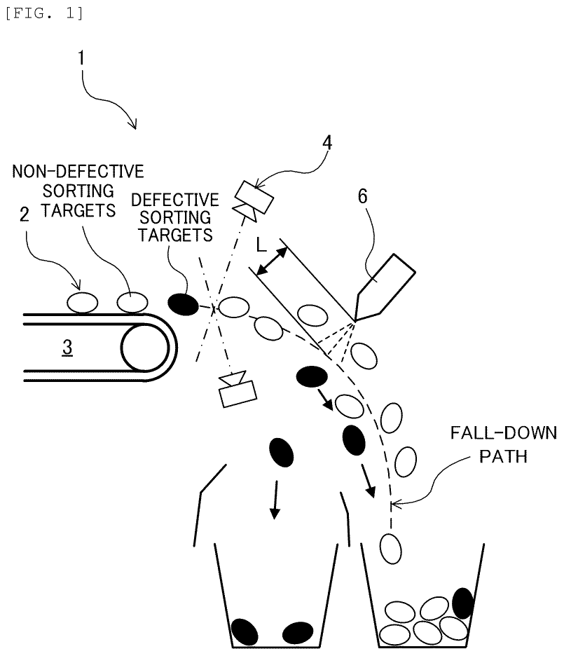

### DESCRIPTION OF EMBODIMENTS

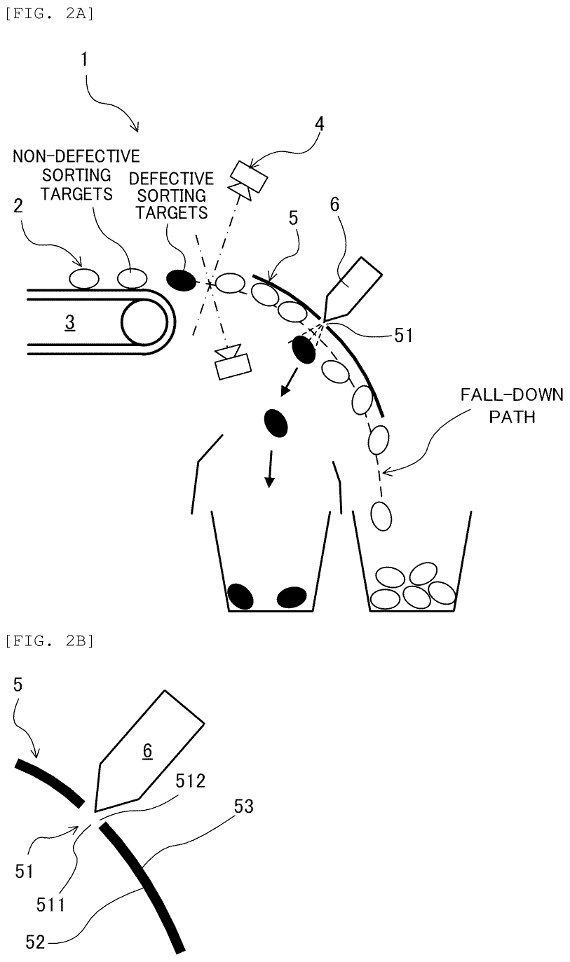

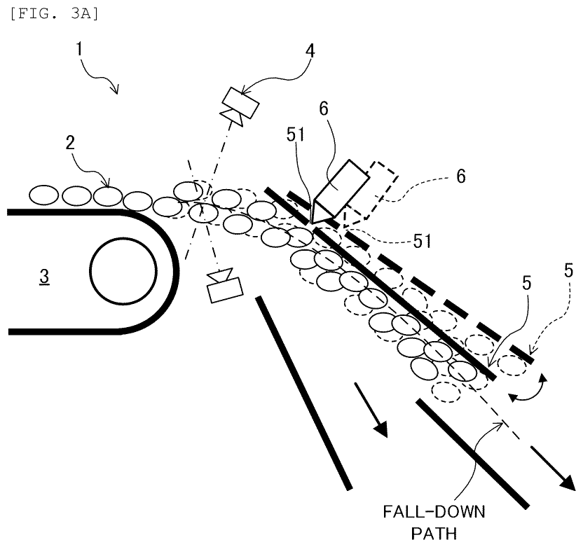

FIG. 2A is an exemplary schematic side view illustrating an aspect of sorting of sorting targets 2 according to the present embodiment. That is, in an optical sorter 1 of the present embodiment, the sorting targets 2 are transported by a transport means 3, such as a conveyor belt. Then, the quality and the like of the sorting targets 2 thrown out from the transport means 3 are optically discriminated by a discrimination means 4, such as an imaging device, while the sorting targets 2 are falling.

A sorting means 6, such as an ejector, is configured to sort the sorting targets 2 that are falling into non-defective ones and defective ones, for example, based on the result of discrimination of the foregoing discrimination means 4. Further, in the present embodiment, a guide plate 5 is provided that is adapted to be contacted by the sorting targets 2 thrown out from the transport means 3 so as to guide the sorting targets 2 to fall in a given falling direction.

More specifically, the foregoing guide plate 5 is arranged at a position above the sorting targets 2 thrown out from the transport means 3, that is, at a position above and in proximity to the ordinary fall-down path (indicated by the dashed line in FIG. 2A) of the sorting targets 2. In addition, as illustrated in FIG. 2B, the guide plate 5 has formed on its lower side a guide face 52 that can be contacted by the sorting targets 2 thrown out from the transport means 3. The guide plate 5 is provided with an opening 51 penetrating the guide plate 5. A guide-face-side opening 511 is formed on the side of the guide face 52 of the opening 51. Further, a rear face-side opening 512 is formed on the side of a rear face 53 of the opening 51. The sorting means 6, which can sort the sorting targets 2 passing through a region ahead of the guide-face-side opening 511, is arranged on the side of the rear face 53 of the opening 51.

Such a configuration allows the sorting targets 2, which have been thrown out from the transport means 3, to slide on the guide face 52 of the guide plate 5, and thus can suppress widespread falling of the sorting targets 2. Further, the sorting targets 2 are allowed to stably fall along the ordinary fall-down path (indicated by the dashed line in FIG. 2A). Besides, the gap between the sorting means 6, which is provided on the side of the rear face 53 of the opening 51 penetrating the guide plate 5, and the ordinary fall-down path (indicated by the dashed line in FIG. 2A) can be significantly reduced than the conventional one. This can increase the sorting accuracy for the sorting targets 2, and thus can more reliably sort the sorting targets 2. As the gap between the sorting means 6 and the ordinary fall-down path (indicated by the dashed line in FIG. 2A) can be significantly reduced than the conventional one, a force required for the sorting action can be reduced than the conventional one. Thus, energy saving can be achieved.

In the present embodiment, an ejector that ejects compressed air is provided as the sorting means 6, and a plurality of ejector nozzles are provided in the depth direction as seen in side view in FIGS. 2A and 2B. Accordingly, as the opening 51 penetrating the guide plate 5, a slit-shaped opening is formed corresponding to the plurality of ejector nozzles. Such a configuration allows a jet of air to be blown onto the sorting targets 2 from a corresponding ejector nozzle based on the result of discrimination of the discrimination means 4 so that sorting can be performed. Note that the shape of the opening 51 is not limited to the foregoing slit shape, and openings (i.e., through-holes) corresponding one-to-one to the ejector nozzles may be provided (for example, 10 openings may be provided if there are 10 nozzles provided in the depth direction of the guide plate 5).

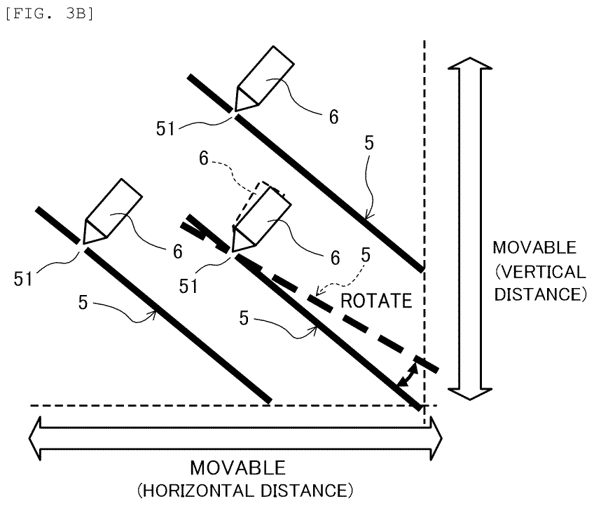

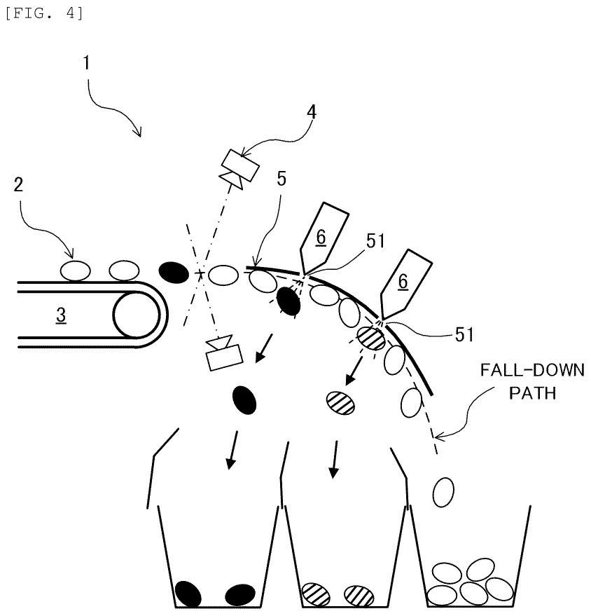

Next, FIG. 3A illustrates a movable aspect of the guide plate 5, and an aspect of falling of the sorting targets 2. FIG. 3B illustrates the movable range of the guide plate 5. As illustrated in the drawings, the position and the like of the guide plate 5 of the present embodiment are adjustable. Such a configuration allows the guide plate 5 to be arranged at an appropriate position corresponding to the ordinary fall-down path of the sorting targets 2.

More specifically, as illustrated in FIG. 3B, the angle of the guide plate 5 can be changed at its opening 51 as a fulcrum (i.e., the center) so that the angle of the guide plate 5 relative to the fall-down path of the sorting targets 2 can be changed. Further, the horizontal distance or the vertical distance of the guide plate 5 from the position of the transport means 3 where the sorting targets 2 are thrown out can be changed as illustrated in the drawing. In this manner, as the guide plate 5 is configured such that its position and angle are adjustable, the guide plate 5 can be arranged at an appropriate position where high sorting accuracy is achieved in accordance with various conditions, such as the types of the sorting targets 2, the type of the transport means 3, and the speed of the sorting targets 2 thrown out from the transport means 3.

Note that the guide plate 5 illustrated in FIGS. 3A and 3B has a linear shape unlike the guide plate 5 of the embodiment illustrated in FIGS. 2A and 2B. However, the cross-sectional shape of the guide plate 5 (along the falling direction of the sorting targets) can be changed as appropriate, and thus can be changed as appropriate in accordance with the direction in which the sorting targets 2 thrown out from the transport means 3 are to be guided, for example. Preferably, the guide plate 5 is arranged with its guide face 52 having an angle close to the ordinary fall-down path of the sorting targets 2 irrespective of the shape of the guide plate 5. Such an arrangement can suppress the bounce of the sorting targets 2 off the guide face 52 of the guide plate 5, and thus can maintain the fall-down path of the sorting targets 2 such that it has a constant width.

In the present embodiment, the guide plate 5 is configured such that its angle is adjustable at its opening 51 as a fulcrum (i.e., the center) as described above, but the present invention is not limited thereto. For example, the guide plate 5 may be configured to be rotatable about any other portion as a fulcrum (i.e., the rotation axis) so that its angle is adjustable.

### Other Embodiments

Although an embodiment of the optical sorter of the present invention has been described above, various modifications are possible as described below.

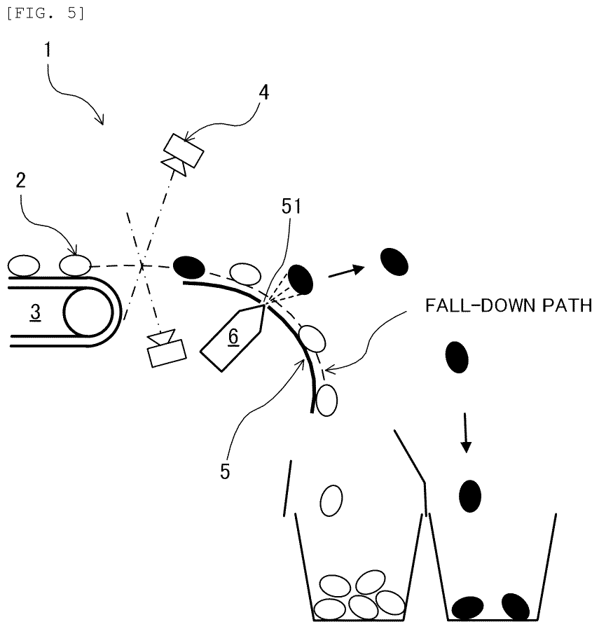

For example, as illustrated in FIG. 4, the guide plate 5 may be provided with a plurality of openings 51 and a plurality of sorting means 6 corresponding to the openings 51. Such a configuration allows for sorting of different types of sorting targets 2. Though not illustrated, it is also possible to provide a plurality of guide plates 5 each having one opening 51 and one sorting means 6. In such a case also, sorting of different types of sorting targets 2 is possible.

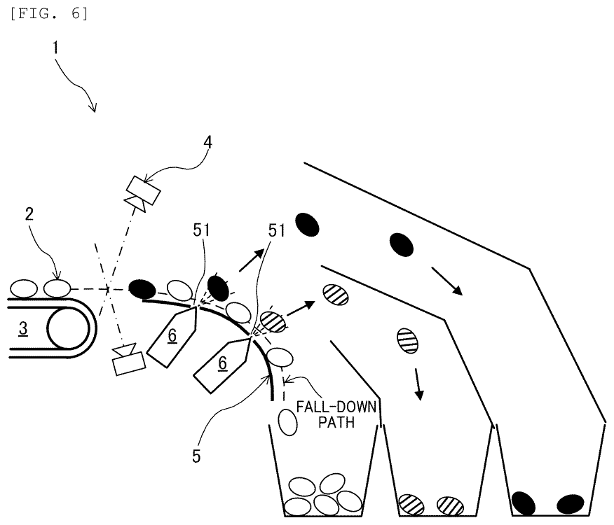

As illustrated in FIG. 5, the guide plate 5 may be arranged below the sorting targets 2 thrown out from the transport means 3. Such a configuration can reduce the gap between the ordinary fall-down path (indicated by the dashed line in the drawing) and the sorting means 6. Thus, it is possible to increase the sorting accuracy for the sorting targets 2, and thus more reliably sort the sorting targets 2.

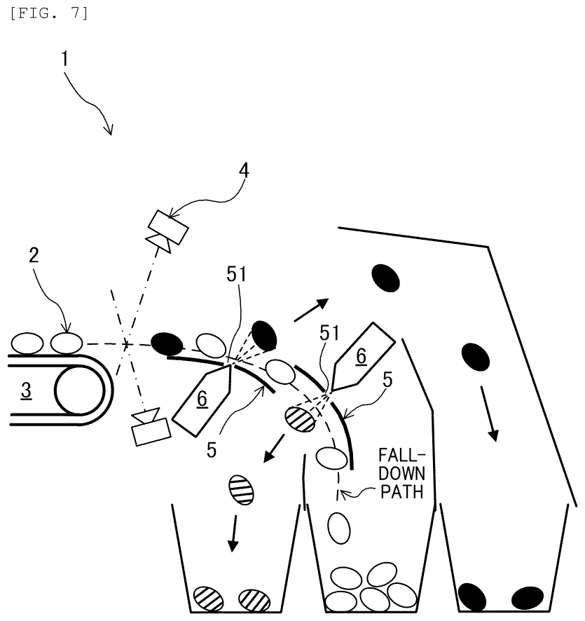

Even when the guide plate 5 is arranged below the sorting targets 2 thrown out from the transport means 3, the guide plate 5 may be provided with a plurality of openings 51 and a plurality of sorting means 6 corresponding to the openings 51 as illustrated in FIG. 6. Such a configuration allows for sorting of different types of sorting targets 2.

Further, as illustrated in FIG. 7, it is also possible to use both a guide plate 5 arranged below the sorting targets 2 thrown out from the transport means 3, and a guide plate 5 arranged above the sorting targets 2 thrown out from the transport means 3, and provide each guide plate 5 with a sorting means 6. Such a configuration allows for sorting of different types of sorting targets 2.

Although each of the foregoing embodiments has exemplarily illustrated an ejector that ejects compressed air as the sorting means 6, the sorting means 6 of the present invention is not necessarily limited to an ejector that ejects compressed air. For example, it is possible to use a flap method or paddle method for sorting the sorting targets 2 by causing a movable piece to contact the sorting targets 2, or a vacuum method for absorbing the sorting targets 2. Even when each of such methods is applied, the gap between the ordinary fall-down path (indicated by the dashed line in the drawings) of the sorting targets 2 and the sorting means 6 can be reduced by the guide plate 5. This can increase the sorting accuracy for the sorting targets 2, and thus can more reliably sort the sorting targets 2.

Although each of the foregoing embodiments has exemplarily illustrated a conveyor belt as the transport means 3, the transport means 3 of the present invention is not necessarily limited to a conveyor belt, and may be a chute-type transport means. It is also possible to provide the guide face 52 of the guide plate 5 with a groove or a regulating plate to prevent the guide plate 5 from having an unbalanced posture when contacted by the sorting targets 2 thrown out from the transport means 3.

The sorting targets 2 of the present invention include not only resin pieces and granular materials including grains and the like, but also cut vegetables and the like that are larger than granular materials. The guide plate 5 of the present invention can be particularly suitably used for granular materials, such as grains, that are likely to bounce.

Although some embodiments of the present invention have been described above, such embodiments of the present invention are merely illustrative to help understand the present invention, and are not intended to limit the present invention. The present invention may be changed or modified without departing from the gist of the invention, and the present invention includes its equivalents. In addition, the components described in the claims and the specification may be combined or omitted within the range that at least some of the foregoing problems can be solved, or within the range that at least some of the advantageous effects can be achieved.

### REFERENCE SIGNS LIST

1 optical sorter
2 sorting targets
3 transport means
4 discrimination means
5 guide plate
6 sorting means
51 opening
52 guide face
53 rear face
511 guide-face-side opening
512 rear-face-side opening

1: An optical sorter comprising:
transport means for transporting sorting targets;
discrimination means for optically discriminating the sorting targets;
sorting means for sorting the sorting targets based on a result of discrimination of the discrimination means; and
a guide plate adapted to be contacted by the sorting targets thrown out from the transport means so as to guide the sorting targets to fall in a given falling direction,
wherein:
the guide plate includes a guide face and an opening, the guide face being capable of being contacted by the sorting targets, and the opening being provided to the guide face and penetrating the guide plate,
the sorting means is arranged around the opening, the sorting means being capable of sorting the sorting targets passing through a region ahead of the opening, and
a position of the guide plate relative to a fall-down path of the sorting targets is adjustable together with the sorting means.

2: The optical sorter according to claim 1, wherein an angle of the guide plate relative to the fall-down path of the sorting targets is adjustable.

3: The optical sorter according to claim 1, wherein a horizontal distance of the guide plate from a position of the transport means where the sorting targets are thrown out is adjustable.

4: The optical sorter according to claim 1, wherein a vertical distance of the guide plate from a position of the transport means where the sorting targets are thrown out is adjustable.

5: The optical sorter according to claim 1, wherein the guide plate is arranged at one or each of a position below and a position above the sorting targets thrown out from the transport means.
